(19) United States
(12) Patent Application Publication
(10) Pub. No.: US 2026/0216770 A1
(43) Pub. Date: Jul. 30, 2026

(54) System and Process for Degassing of Pyrolysis Plastics

(71) Applicant: BlueAlp Innovations BV, Eindhoven (NL)

(72) Inventors: Rik GOLDSMITS, Eindhoven (NL); Sem HEIJMANS, Eindhoven (NL); Rob BRAAT, Eindhoven (NL); Teunis Christiaan VAN DER REE, Groot-Ammers (NL)

(73) Assignee: BlueAlp Innovations BV, Eindhoven (NL)

(21) Appl. No.: 19/140,038

(22) PCT Filed: Dec. 28, 2023
(86) PCT No.: PCT/EP2023/087935

§ 371 Date: Jun. 17, 2025

(30) Foreign Application Priority Data
Dec. 28, 2022 (NL) 2033861

(51) Int. Cl. B09B 3/70; B01J 6/00; B09B 3/40; B09B 101/77; C10G 9/00

(52) U.S. Cl. CPC B09B 3/70; B01J 6/008; B09B 3/40; C10G 9/00; B09B 2101/77; C10G 2300/1003

(57) ABSTRACT

There is described a process and apparatus for lowering halogen, preferably chlorine, content of a waste-plastics material. The process comprises the steps of: heating a body of halogen containing melted plastics in a first heating zone to a temperature within the range of about 220° C. to about 350° C., producing a mixed body of liquid phase and a gas phase, the gas phase being dispersed within the liquid phase; passing the mixed body of dispersed gas and liquid via an outlet of the first heating zone to a degassing chamber; allowing the dispersed gas phase to separate from the liquid phase in the degassing chamber to provide a body of predominantly gas phase material comprising halogen containing compounds, preferably comprising hydrogen chloride, and a body of liquid phase plastics material; releasing at least a portion of the gas phase from the degassing chamber via a gas outlet in the degassing chamber; and passing the liquid phase material via a liquid outlet in the degassing chamber, to one or more subsequent heating zones and further heating the liquid phase to a higher temperature that is a pyrolysis temperature.

### FIELD OF THE INVENTION

The invention generally concerns methods and apparatuses to process waste plastics by means of pyrolysis, as well as the products obtained thereby. More specifically the invention concerns methods and apparatuses for heating the waste plastics to cracking temperatures while removing potential product pollutants such as halogens, especially chlorine. Furthermore, the invention refers to a system for the separation of gas, liquid, and optionally solid particles in a molten plastic material. The invention further concerns a method and system to crack long-chain hydrocarbons and to separate the resulting products and in particular refers to a method and system to process plastics and polyolefins by means of cracking.

### BACKGROUND OF THE INVENTION

Large quantities of waste plastics are generated in the present society. While recycling of plastics is becoming ever more efficient and effective, it is still the case that much of the waste plastic cannot be effectively or efficiently recycled and is disposed of to landfill sites where it takes many years to degrade, or it may be lost to the environment where it can be damaging to ecosystems.

Plastic materials are however made of essentially useful compounds that can be used as is and/or converted for (re)use. For example, fuels such as diesel may be derived from waste plastics, or waste plastics may be converted to raw material suitable for synthesis of new materials, such as new plastics, other hydrocarbon materials, or similar. Materials recovered from waste plastics may be useful to at least partially replace hydrocarbons more traditionally obtained from natural gas or mineral oils.

The output of plastic-to-chemical plants typically includes light hydrocarbons (LHC), heavy hydrocarbons (HHC), char, and non-condensables (gases). Currently, LHC, HHC, or mixtures thereof, are the most desirable products, however, this is market dependent.

LHC and HHC fractions are required by industry to meet certain chemical and physical specifications such as vapor pressure, initial boiling point, final boiling point, Flash point, viscosity, cloud point and cold filter plugging point. Different qualities may be desired by different customers or end-uses, but it is important that plastic-to-chemical plants produce product of stable quality. The final qualities of the product fractions is controlled by a distillation column such as those well-known and commonly used in the petrochemical industry. It is desirable that the fractions are relatively pure such that light hydrocarbons fraction and heavy hydrocarbons do not contain large portions of high boiling point compounds. Such high boiling point compounds can increase cold filter plugging points, cloud point and are often unacceptable to pyrolysis oil purchasers.

In plastic-to-chemical plants, feedstock plastics, which may comprise for the most polyethylene and polypropylene from domestic sources, form the input. These plastics made up of very long chain hydrocarbons are then cracked into shorter chains, forming a wide spectrum of molecules with a variety of chain lengths. These mixtures can be distilled into various temperature-determined fractions as is known.

A known process in the art for converting waste plastic to, among other things diesel, is the thermochemical breakdown process of pyrolysis. Pyrolysis is the thermal decomposition of the waste plastics in an inert atmosphere. In effect, the long polymer chains of the plastic's polymers are cracked through heating, resulting in shorter hydrocarbon chains, which are generally more useful as a product.

Pyrolysis is a preferred method of performing thermochemical break down of waste plastic materials. Various attempts to provide technically and cost-effective pyrolysis of waste plastic have been attempted previously.

Technically useful results have been achieved by the technologies discussed in patent publications US2018/0010050 and WO2021053139, the contents of which publications are incorporated herein by reference.

US2018/0010050A1, discusses a method for recovering hydrocarbons from plastic wastes by pyrolysis without the use of catalysts, in particular polyolefin-rich waste. The process involves melting the plastic waste in two heating devices and mixing a stream derived from a cracking reactor with the incoming molten plastic waste of a first heating device. The heated, molten plastic is passed to a cracking reactor where the plastic materials are cracked. Subsequent thereto the cracked materials are distilled into diesel and low boilers.

WO 2021/053139 A1 which offers a number of advancements in relation to US2018/0010050A1, discusses, among other matters, a method for breaking down long-chain hydrocarbons from plastic-containing waste, comprising providing material containing long-chain hydrocarbons; heating a specific volume of the material containing long-chain hydrocarbons to a cracking temperature, at which cracking temperature the chains of hydrocarbons in the material start cracking into shorter chains; and for the specific volume having a temperature above the cracking temperature, exposing the specific volume to heat which is less than or equal to 50° C. above the temperature of the specific volume. After the specific volume of the material has been exposed to heat, WO 2021/053139 passes the partially cracked stream of molten plastic to a gas-liquid separation structure. The separation structure, also referred to as reactor, includes a separation zone containing a gas-liquid phase boundary, and a settling zone for heavy hydrocarbons and/or solid carbon, as well as potentially other solids such as aluminium, sands, dirt, etc., to accumulate.

Although good results have been achieved based on the above technologies, there remains room for further improvement, for example it would be useful to provide systems and processes that are more versatile than previously attempted systems.

EP 2 876 146 B1 discusses tested technology in which a process for recovering hydrocarbons from polyolefin plastic recyclables by means of pyrolytic cracking comprises: introducing the plastic recyclables into a mixing vessel under inert gas and mixing with diesel oil, removing water vapor in a first heating zone, removing acidic gases in a second heating zone, liquefying those not yet melted Plastic recyclables in a third heating zone, cracking of the plastic recyclables in a cracking reactor at approx. 400 degrees centigrade, partial condensation to prevent the discharge of paraffins, fractionation of the cracked products.

While the present invention has a general aim to improve the overall system of such pyrolysis processes and apparatuses, aspects of improvement may preferably include one or more of the following.

In an aspect it is an object of the present invention to provide alternatives, and preferably improvements for pyrolysis processes and apparatuses. These may assist in lowering halogen, preferably chlorine content, of waste plastics prior to or during pyrolysis.

It is also an object of the present invention to provide an improved method for breaking down long chained hydrocarbons.

In an aspect of the invention, it may be useful to achieve better control of product quality and improved yield of product fractions that are sent to distillation, and which fractions are eventually distilled. For example, it may be desirable to deal with broad content feedstocks comprising halogen containing plastics such as PVC, yet at the same time be able to produce relatively pure hydrocarbon products with little to no remaining halogen content (e.g. Cl). It may also be, for example, an aim to achieve more commercially useful ratios of non-condensables, light hydrocarbon fractions, and heavy hydrocarbon fractions in the product streams, while at the same time minimizing halogen content in such products.

In an aspect of the invention, it may be desirable to improve reliability of processes.

In an aspect of the invention, it may be desirable to improve or limit downtime of the system.

It is a non-limiting object of the present invention to provide efficient, versatile, and/or robust processes and apparatuses for conversion of waste plastic to useful product streams, e.g. non-condensable gasses, light hydrocarbons, heavy hydrocarbons, paraffins, bitumen, tar and other similar derivable fractions. In this respect the invention may address, for example, one of more of the foregoing problems or at least provide the technical arts with a useful choice.

Attempts to achieve effective pyrolysis of waste plastics have been previously made.

An example is discussed in patent publication WO11077419 A1 referring to a process for treating waste plastics, in which plastic is melted and then pyrolyzed in an oxygen-free atmosphere in a jacket-heated pyrolysis vessel to provide pyrolysis gases. The pyrolysis gases upwardly flow via a pipe directly linking the pyrolysis chamber to a contactor vessel, into contact with plates in the contactor vessel so that some long chain gas components condense. The condensed liquid is directly returned by downward flow through the same pipe, to the pyrolysis zone. The condensed liquid is then reheated within the pyrolysis zone and further pyrolyzed. The short chain gas components exit the contactor in gaseous form and proceed to distillation.

It is explained in WO11077419 A1 that as a batch ends, increased load on a pyrolysis chamber agitator indicates that char drying is taking place, and that the process is ending. The pyrolysis chambers are then purged by operating double-helical agitator blades in reverse to remove char, and nitrogen is passed up through the contactor and out directly to thermal oxidisers to flush any remaining hydrocarbons, during which phase the pyrolysis vessel and contactor are isolated from the rest of the system. Such a process and system can be problematic and suboptimal. For example, the inclusion of an agitator in the pyrolysis chamber, as well as jacketed direct heating of the pyrolysis chamber, is complex yet necessary. The system also makes use of a specific type of jacket-cooled contactor with cooled contactor baffle plates that are sloped and comprise apertures, to give direct return of condensed hydrocarbons from the contactor to the pyrolysis chamber via the same pipe by which pyrolysis gases entered the contactor. This can be complex; the pyrolysis process leads to batch completion with a dry char (carbon) product; and purging associated with extended downtime of pyrolysis reactors.

There are prior attempts in which a partial condenser has been arranged directly on top of a pyrolysis vessel to return heavy hydrocarbons for further cracking. Some of these attempts have been found to be less versatile, robust, and efficient than is optimal. Without being bound by theory, and by identification through technical investigation, it may be that the condensed liquid returning from the partial condenser directly into a pyrolysis reactor vessel can lead to temperature inconsistencies and heat loss in a pyrolysis zone, requiring complex heat input at the pyrolysis zone, with possible hot spots, charring, complex agitation, and/or energy loss. Provision of a process and system that suffers less from such disadvantages may be desirable.

Another example is discussed in CH708681A1, which refers to a process for recovering hydrocarbons from polyolefin plastic recyclables by means of pyrolytic cracking. Plastic recyclables are introduced into a mixing vessel under inert gas and mixing with diesel oil, removing water vapor in a first heating zone, removing acidic gases in a second heating zone, liquefying those not yet melted plastic recyclables in a third heating zone, cracking of the plastic recyclables in a cracking reactor at about 400° C., partial condensation to prevent the discharge of paraffins, and fractionation of the cracked products.

The partial condenser in CH708681A1 is separate and spaced from the pyrolysis reactor, with a communicating pipe leading pyrolyzed gases from the pyrolysis reactor to the partial condenser. The partial condenser is adjusted so that heavy hydrocarbons that are not of the desired product character condense and are led back into a third heating zone, via a separate pipe, where they can be further cracked. The additional cracking loop reduces the inclusion of overly heavy hydrocarbons in the product.

Attempts to implement related concepts to those disclosed in CH708681A1 were found to workably result in product but showed some instability in pyrolysis and inefficiencies, for example, requiring complex heating in the pyrolysis zone. In addition, the system of CH708681A1 may be complex to implement because of differential pressures between the partial condenser and the heating zone to which the heavy hydrocarbons are returned.

Other attempts have included U.S. Pat. No. 10,160,920 BB with a sequential cracking process for the thermal cracking of a hydrocarbon feedstock in a cascade of cracking units; US2007227874 AA discussing a method for recovering fractional hydrocarbons from recycled plastic; and U.S. Pat. No. 5,580,443 A which discusses a process for thermally cracking a low-quality feed stock containing a considerable proportion of heavy fractions such as high-boiling fraction.

In US2018/0010050A1, a purified, pre-sorted polyolefin-rich waste is used as a feedstock. Those plastic materials, although sorted, may still contain interfering substances, such as chlorine-and/or sulfur-containing compounds, rubber, metals, sand, etc., which are said to be removed at a later point in the method.

The feedstock mixture is supplied to a compactor in which the plastic mixture is homogenized and heated essentially due to friction. The material in the compactor is heated to a temperature of 120 to 150 degrees centigrade in the compactor and water vapor is removed under vacuum.

The material is subsequently conveyed into an extruder where it is heated to approximately 250-300 degrees centigrade. Plastic fractions containing sulfur and chlorine are destroyed and HCl and H₂S are discharged from the extruder via a vacuum pump. The acidic pollutants are preferably neutralized in a scrubber and disposed of.

The extruder then passes the material to heat exchangers (tube and shell) where the reusable plastic materials is further heated to approximately 380 degrees centigrade in order to completely melt. In a second, subsequent heat exchanger the plastic melt is heated to 400 degrees centigrade and is then passed into a cracking reactor.

WO 2021/053139 A1, which offers a number of advancements in relation to US2018/0010050A1, also discusses degassing from the extruder.

WO 2022/147473 discusses methods for pyrolyzing mixed plastic waste streams to produce lowered chloride content oil product. In an embodiment, the mixed plastic waste at the processing end of a mechanical recycling facility (MRF) that is otherwise sent to a landfill is used for pyrolysis feedstock. A mixed feed stream is added to a melting reactor that is said to act as a dechlorination reactor and may operate at a temperature from 200 degrees centigrade to about 350 degrees centigrade, or 280 degrees centigrade to 320 degrees centigrade. It is said that in the melting reactor polyvinyl chloride is mostly pyrolyzed through an “unzipping” reaction where chloride molecules are easily removed through a pyrolysis free radical reaction and abstract hydrogen in nearby sites to form hydrogen chlorides. The temperature of the melting reactor is said to melt plastic components yet and to yield hydrogen chlorides. The produced gas containing hydrogen chlorides is sent to be burnt while the liquid is sent directly to a pyrolysis chamber. Improvements and alternatives to such a system are desirable.

All references, including any patents or patent applications cited in this specification are hereby incorporated by reference. No admission is made that any reference constitutes prior art.

### SUMMARY

While the invention is defined in the independent claims, further aspects of the invention are set forth in the dependent claims, the drawings, and the following description.

aspect of the invention there is provided a process for heating a halogen containing plastics material to pyrolysis temperature, the process comprising the steps of:
heating and melting a halogen containing solid plastic feedstock, for example waste-plastic particles or waste-plastic pellets comprising polyvinylchloride, to a temperature within the range of about 200° C. to about 325° C., preferably about 210° C. to about 300° C., more preferably about 220° C. to about 280° C., most preferably to about 260° C.;
removing water vapour and other gases emergent in the fluidizing and heating step;
passing the melted plastics material to a first heating zone,
further heating the body of melted plastics in said first heating zone to a higher temperature within the range of about 220° C. to about 350° C., more preferably from about 280° C. to about 340° C., more preferably from about 300° C. to about 330° C., most preferably to about 330° C., producing a liquid phase and a gas phase, the liquid phase and gas phase being intermixed in the first heating zone;
allowing the liquid phase and gas phase to separate to provide a body of predominantly gas phase material comprising at least halogen containing compounds (possibly further non-halogen contaminants that are in the gas phase), preferably chlorine, and a body of liquid phase plastics material;
removing at least a portion of the gas phase;
passing the liquid phase material to one or more subsequent heating zones and further heating the liquid phase to a higher temperature that is a pyrolysis temperature; and
preferably passing an output liquid phase of the heating zones, at said pyrolysis temperature, to a pyrolysis reactor and/or distillation apparatus.

In an aspect of the invention, there is provided an apparatus for heating a halogen containing plastics material to pyrolysis temperature, the device comprising:
a heating and melting section arranged to heat and melt a halogen containing solid plastic feedstock, optionally or alternatively a bio-organic feedstock, for example waste-plastic particles or waste-plastic pellets comprising polyvinylchloride, to a temperature in the range of about 200° C. to about 325° C., wherein the heating and melting section is provided with an inlet for said plastic feedstock, at least one gas outlet for release of gases emergent from the plastic feedstock during heating and melting, and an outlet for molten plastics material;
a first heating zone arranged to be fed molten plastics material from the heating and melting section, and further arranged to heat melted plastics material to a temperature in the range of about 220° C. to about 350° C. producing a liquid phase and a gas phase, the liquid phase and gas phase being intermixed in the first heating zone;
a degassing zone provided with an inlet arranged to be fed intermixed liquid phase and gas phase from the first heating zone, the degassing zone being arranged to allow said intermixed liquid phase and gas phase to separate into a body of predominantly gas phase material and a body of liquid phase plastics material; the degassing zone further comprising an gas outlet for release of said gas phase and a liquid outlet for release of said liquid phase, preferably wherein the gas outlet is higher than the liquid outlet;
at least one subsequent heating zone arranged to receive said liquid phase from the degassing zone liquid outlet, the heating zone being arranged to heat the liquid phase to a higher temperature, preferably to a pyrolysis temperature.

In an aspect of the invention there is provided a process for lowering halogen, preferably chlorine, content of a waste-plastics material, comprising the steps of:
heating a body of halogen containing melted plastics in a first heating zone to a temperature within the range of about 220° C. to about 350° C., more preferably from about 280° C. to about 340° C., more preferably from about 300° C. to about 330° C., most preferably to about 330° C., producing a mixed body of liquid phase and a gas phase, the gas phase being dispersed within the liquid phase;
passing the mixed body of dispersed gas and liquid via an outlet of the first heating zone to a degassing chamber,
allowing the gas phase to separate from the liquid phase in the degassing chamber to provide a body of predominantly gas phase material comprising halogen containing compounds, preferably comprising hydrogen chloride, and a body of liquid phase plastics material;
releasing at least a portion of the gas phase from the degassing chamber via a gas outlet in the degassing chamber; and
passing the liquid phase material via a liquid outlet in the degassing chamber, to one or more subsequent heating zones and further heating the liquid phase to a higher temperature that is a pyrolysis temperature.

In an A process for lowering halogen, preferably chlorine, content of a waste-plastics material, comprising the steps of:
heating a body of halogen containing melted plastics in a first heating zone to a temperature within the range of about 220° C. to about 350° C., more preferably from about 280° C. to about 340° C., more preferably from about 300° C. to about 330° C., most preferably to about 330° C., producing a mixed body of liquid phase and a gas phase, the gas phase being dispersed within the liquid phase;
passing the mixed body of dispersed gas and liquid via an outlet of the first heating zone to a degassing chamber,
allowing the gas phase to separate from the liquid phase in the degassing chamber to provide a body of predominantly gas phase material comprising halogen containing compounds, preferably comprising hydrogen chloride, and a body of liquid phase plastics material;
releasing at least a portion of the gas phase from the degassing chamber via a gas outlet in the degassing chamber; and
passing the liquid phase material via a liquid outlet in the degassing chamber, to one or more subsequent heating zones and further heating the liquid phase to a higher temperature that is a pyrolysis temperature.

In an aspect of the invention there is provided a process for lowering halogen, preferably chlorine, content of a waste-plastics material, comprising the steps of:
heating a body of halogen containing melted plastics in a first heating zone to a temperature within the range of about 220° C. to about 350° C., more preferably from about 280° C. to about 340° C., more preferably from about 300° C. to about 330° C., most preferably to about 330° C., producing a mixed body of liquid phase and a gas phase, the gas phase being dispersed within the liquid phase;
passing the mixed body of dispersed gas and liquid via an outlet of the first heating zone to a degassing chamber,
allowing the gas phase to separate from the liquid phase in the degassing chamber to provide a body of predominantly gas phase material comprising halogen containing compounds, preferably comprising hydrogen chloride, and a body of liquid phase plastics material;
releasing at least a portion of the gas phase from the degassing chamber via a gas outlet in the degassing chamber; and
passing the liquid phase material via a liquid outlet in the degassing chamber, to one or more subsequent heating zones and further heating the liquid phase to a higher temperature that is a pyrolysis temperature.

In an aspect of the invention there is provided an apparatus for heating a halogen containing plastics material to pyrolysis temperature, the device comprising:
a first heating zone arranged to be fed molten plastics material and to increase the temperature of said melted plastics material to a temperature in the range of about 220° C. to about 350° C. producing a liquid phase and a gas phase, the liquid phase and gas phase being intermixed in the first heating zone;
a degassing zone provided with an inlet arranged to be fed said intermixed liquid phase and gas phase from the first heating zone, the degassing zone being arranged to allow said intermixed liquid phase and gas phase to separate, preferably under gravity, into a body of predominantly gas phase material and a body of predominantly liquid phase plastics material; the degassing zone further comprising a gas outlet for release of said separated gas phase and a liquid outlet for release of said separated liquid phase, preferably wherein the gas outlet is positioned higher than the liquid outlet;
at least one subsequent heating zone arranged to receive said liquid phase from the degassing zone liquid outlet, the at least one subsequent heating zone being arranged to heat the liquid phase to a higher temperature, preferably to a pyrolysis temperature.

It is a preferred feature that the separation of the dispersed gas separates from the melted plastics liquid in a settling zone, that is, a volume in which the dispersed gas has a residence time allowing dispersed gas bubbles to rise, and preferably coalesce, out of the liquid body, thereby forming a body of gas above the liquid. That body of gas above the liquid may then be selectively released from the degassing zone.

In an aspect of the invention, the liquid phase flows continuously through the degassing zone from the inlet to the liquid outlet. That is, the liquid body is constantly flowing in a direction from the inlet to the liquid outlet. Residence time for a quantum of the liquid body in the degassing zone is determined by the distance from the inlet to liquid outlet and the speed of flow of the liquid body. Continuous flow combined with degassing is believed to be advantageous in supporting a continuous pyrolysis process, that is less subject to the problems of batch processing.

Without wishing to be bound by theory, it is contemplated that through application of the temperatures as discussed, the first heating zone will tend to more thoroughly pyrolyze plastics such as PVC, and effect less pyrolysis on PE or PP. The gas in degassing zone will in that manner tend to comprise a high proportion of chlorine containing compounds, and the first heating zone, together with degassing may so provide a step to conveniently remove halogen materials prior to further processing, pyrolysis, of the PE and PP plastics, which form the more useful feedstock components.

It is a preferred feature of the processes that a continuous plastics treatment process is provided, for example a continuous throughput first heating zone and continuous throughput degassing zone, as opposed to batch type handling. Continuous processing techniques are believed to be advantageous in many respects to batch type processing, which necessarily requires temporary shut-down of (modules within) a process.

For example, the first heating zone may be provided as a tube and shell heat exchanger through which melted plastics material heated during transition therethrough, the melted plastics material being passed through tubes.

For example, the mixture of disbursed gas in melted liquid plastic may be passed as a continuous stream through a degassing zone having length in a flow direction. The residence time preferably allowing for bubbles of dispersed gas to rise out of the liquid body, prior to the liquid phase material passing to the one or more subsequent heating zones for further pyrolysis. The separation of the intermixed liquid phase and gas phase preferably occurs under gravity with the gas phase rising out of the liquid phase due to density differences.

Residence time of the dispersed gas and melted plastic liquid may be achieved via control of a rate of flow of the materials through the settling zone (i.e. from liquid inlet to liquid outlet) in combination with a length of the settling zone in a flow direction, as well as a height of the liquid outlet within the degassing zone. For example, a flow rate and length of the degassing zone may be controlled to allow the bubbles of gas to rise above the level of the liquid outlet prior to liquid exit from the liquid outlet from the degassing zone.

Preferably the degassing zone comprises a degassing vessel that is distinct from the heating zones, for example is a distinct vessel intermediate the first heating zone and subsequent heating zone. Preferably the degassing vessel is a domed chamber forming a degassing dome.

Where the degassing zone comprises a degassing chamber, the degassing chamber is A process in accordance with claim 39 wherein the degassing chamber is vertically elongate having height, the chamber being provided with a liquid inlet, the liquid outlet being arranged lower in the height of the chamber than the gas outlet, wherein the process further comprises the steps of passing the mixed body of dispersed gas and liquid via the outlet of the first heating zone to the liquid inlet of the degassing chamber.

The degassing chamber is vertically elongate having height, the chamber being provided with a liquid inlet, the liquid outlet being arranged lower in the height of the chamber than the gas outlet, wherein the process further comprises the steps of passing the mixed body of dispersed gas and liquid via the outlet of the first heating zone to the liquid inlet of the degassing chamber. A liquid level may then be maintained between the gas outlet and the liquid outlet, allowing consistent removal of gas and removal of liquid phases. The rate of gas production due to pyrolysis together with a downstream pressure in the system determines the liquid level, downstream here referring to back pressure from the downstream liquid pyrolysis sections. It is desirable that minimal levels to no gas phase be removed via the liquid outlet because the gas will contain halogen materials. Minimal levels of liquid phase material are removed via the gas outlet, the gas phase is preferably saturated and condensation of liquid may occur with temperature or pressure change in the gas outlet and downstream thereof. In preferred embodiments the gas outlet and associated piping or other elements may be heated to minimize or avoid condensation of the gas phase, such heating may be in the form of electrical tracing, a thermal oil jacket or similar. The heating may also be used for hot standby and/or start-up modes.

Alternatively, the degassing chamber is preferably vertically elongate, the chamber being provided with said liquid outlet in a lower half of a height of the chamber and said gas outlet being arranged in an upper half of the height of the chamber.

Preferably the gas outlet is in positioned in the upper half of the degassing vessel, preferably at the top of the degassing vessel.

The degassing vessel is preferably elongate and arranged with vertical height. The height of the degassing vessel provides a tolerance buffer allowing for some variation in liquid level within the degassing vessel.

In that respect, it is advantageous to control a liquid level in the degassing chamber, for example by determining a liquid level and adjusting a rate of gas release from the gas outlet to maintain the liquid level in the degassing chamber below the gas outlet and above the liquid inlet and liquid outlet. Gas release preferably aligns with release of pressure in the gas phase volume of the degassing zone, allowing the liquid level to rise.

In addition to, or alternatively, the liquid level in the degassing chamber may be adjusted by control of a rate of input and/or output of liquid for the degassing chamber to maintain the liquid level in the degassing chamber below the gas outlet and above the liquid inlet and liquid outlet.

Preferably the degassing zone comprises liquid level monitoring sensors, preferably radar, temperature, and/or gamma ray sensors. One, more or all of these sensors may provide a convenient and robust determination of liquid level in the degassing zone, preferably degassing vessel.

A temperature measurement level sensor arrangement may comprise a vertically arranged rod provided with multipoint temperature measurement sensors. The multipoint temperature measurement is placed inside the degassing vessel and the level of the liquid can be assessed based on a difference in temperature between adjacent sensors on the rod, for example a difference of from 3° C. to 6° C. between the gas and liquid phase.

Gamma source level measurement devices may be placed externally and a liquid level determined based on sensing whether gamma radiation is blocked by presence of liquid. It has been found that radioactive level measurement provides accurate liquid level measurement despite dynamic processes and conditions in the degassing zone, including foaming and potential fouling. In particular, radioactive level measurement does not require internal probes or other internal sensors.

A radar measurement device may be provided, preferably a guided wave radar measurement. The guided wave radar measurement is placed inside the separation vessel 12. A guided wave radar level transmitter is placed on top of the degassing vessel. The guided wave radar measurement may provide a broad operating range, with good reliability. In particular, a rod type guided wave radar is suited for operation with foaming liquids, and the measurement operates independently of noise, pressure, temperature and density variations. Furthermore, fouling on the guided wave radar probe or on the separation vessel's inner surfaces, have minimal influence on the measurement accuracy.

In the event of sudden or unwanted rises in liquid level in the degassing zone, this may be counteracted by injection of an inert gas, e.g. nitrogen gas, into the degassing zone, preferably the gas volume of the degassing zone. This may be implemented to increase pressure and lower the liquid level.

The passage of the melted plastic for pyrolysis as a continuous process is advantageously achieved by arranging the heating zones and degassing zones in series. Preferably such that a unit of plastic material entering the process is continuously flowed through the process at least until exit into a final pyrolysis chamber, separation container or distillation process, and preferably is not retained in a vat container or batch type processing step.

It is preferable that the plurality of heating zones are arranged in series and at least one or more downstream heating zones are positioned higher than an upstream heating zone.

To provide good separation of gas from the liquid, the liquid and gas mixture is preferably not agitated by mechanical agitators in the settling or degassing zone.

The degassing zone or degassing zones are preferably not heated or are only maximally heated to maintain a temperature of the body of melted liquid. Preferably the temperature within the degassing zone immediately downstream of the first heating zone is controlled to be maximally about 350° C., preferably maximally 325° C.

The separation of the intermixed liquid phase and gas phase of the first heating zone preferably occurs predominantly downstream of the first said heating zone, preferably prior to a subsequent heating zone.

Once the liquid material has exited the degassing zone it is further heated to a higher temperature in one or more subsequent heating zones. The temperature to which it is heated is a pyrolysis temperature, preferably in the range from about 360° C. to about 550° C., preferably from about 390° C. to about 450° C. prior to being passed as an output liquid phase of the heating zones to a pyrolysis reactor and/or distillation apparatus. Preferably a final heating zone is provided, which final heating zone heats the melted plastic liquid to a temperature in the range of about 360° C. to about 550° C., preferably from about 390° C. to about 450° C.

The one or more subsequent heating zones are preferably also heat exchangers, preferably tube and shell heat exchangers. These may advantageously assist in provision of a continuous process for plastics processing, as opposed to batch processing.

Although it is preferred that separation of the intermixed liquid phase and gas phase of the first heating zone preferably occurs predominantly downstream of the first said heating zone and preferably prior to a subsequent heating zone, further degassing zones may be provided between subsequent heating zones, each degassing zone preferably being the same or similar to the first degassing zone.

For example, it may be preferable to provide two, three, four or more heating zones. A degassing zone is preferably provided between the first and second heating zones for removal of halogen containing gases. In addition, more degassing zones may be provided between other heating zones, or even between all heating zones, for example a degassing zone may be provided between heating zones two and three and/or heating zones three and four, and so on if further heating zones are provided.

It is preferred that according to any preceding claim an extruder is provided and that the heating and melting of the halogen containing solid plastic feedstock is done in the extruder.

The extruder may preferably be provided with a compression section, optionally comprising heating such as thermal oil heating or electrical heating, and an expansion section downstream of the compression section; wherein the compression section is arranged to compress and heat said solid plastic feedstock, and the expansion section is arranged to allow expansion of compressed plastics material and liberate gases, preferably air and water vapour, from the plastics material, wherein the extruder is provided with a gas outlet in communication with the expansion section whereby gases may be removed from the expansion section.

Preferably in the extruder, following the expansion section, compression and heating is applied to the plastics material.

Preferably a step of heating and melting a halogen containing solid plastic feedstock to make it liquid, and optionally to remove water, comprises
compressing and heating the plastic feedstock to a temperature greater than 100° C., preferably to a temperature within the range of about 200° C. to about 320° C.,
thereafter reducing the pressure in at least one expansion zone, preferably a plurality of expansion zones, to liberate gases, preferably at least air and water vapour, optionally also further contaminants such as bio-organics;
removing at least a portion of said liberated gases from the extruder; and
thereafter compressing and heating remaining plastics material to a temperature from about 200° C. to about 320° C.

It is preferable that the first heating zone is fed by an extruder, for example an extruder as discussed above.

It is possible to apply negative pressure at a gas outlet of the degassing zone to assist removal of gas phase material. Reference to negative pressure here is reference to pressures lower than the pressure in the degassing zone.

Although chlorine is likely the most commonly found halogen in plastic waste streams, on account of a prevalence of PVC plastics in domestic use, other halogens and non-halogen contaminants may alternatively or simultaneously be removed. The removed halogen may be selected from the group consisting of chlorine, bromine, fluorine, and mixtures thereof, preferably the halogen comprises chlorine.

The removed halogen (chlorine) containing gas may preferably be treated. For example, the gas phase material comprising halogen containing compounds, such as HCl, may be passed to a scrubber, preferably an alkali scrubber, more preferably a caustic scrubber.

Waste plastic feedstock for the invention may preferably comprise polyethylene and/or polypropylene plastics. Preferably the sum of polyethylene and polypropylene in the feedstock is at least 50 wt. % by weight of the feedstock, more preferably at least 60 wt. %, still more preferably at least 75 wt. %, most preferably at least 90 wt. %. These materials represent a large portion of domestic plastic waste and are treatable by pyrolysis. The preferred plastic for the feedstock is polyethylene or polypropylene The feedstock used in any of the embodiments may comprise polyvinylchloride plastics. Preferably the solid plastic feedstock comprises polyvinylchloride plastics, preferably greater than 1 wt. % of polyvinylchloride plastics, more preferably greater than 5 wt. %, or wherein the feedstock comprises polyvinylchloride plastics at less than 5 wt. %, more preferably less than 1 wt. %.

The solid plastic feedstock may comprise polyethylene terephthalate plastics, preferably greater than 3 wt. % of polyethylene terephthalate plastics, more preferably greater than 4 wt. %, or wherein the feedstock comprises less than 4 wt. % of polyethylene terephthalate plastics, more preferably less than 3 wt. %.

A process according to any preceding claim wherein the solid plastic feedstock comprises polystyrene plastics, preferably greater than 1 wt. % of polystyrene plastics, more preferably greater than 5 wt. %, or wherein the feedstock comprises less than 20 wt. % of polystyrene plastics, more preferably less than 5 wt. %.

Pyrolysis temperatures may vary within a limited range dependent upon factors such as feedstock makeup and operating pressures, preferably the plastics material is heated to a pyrolysis temperature of 360° C. or more, about 390° C. or more, more preferably about 400° C. or more, up to about 450° C., although higher temperatures up to about 500° C. or about 550° C. may be implemented. The plastic pyrolysis may start from about 360° C., and so such temperatures may also be contemplated. Pyrolysis is, however, more significant at or above about 390° C., which may allow for a more economically attractive process.

The term “pyrolysis zone” as used herein refers to zones in which materials that are processed by the process or system (e.g. waste plastic or the derivates thereof generated by pyrolysis in the process or system) are at pyrolysis temperatures, for example at temperatures at or above 360° C., more preferably at temperatures at or above 390° C., still more preferably at or above 400° C. Pyrolysis zones are preferably those zones in the process or system in which the processed materials are at temperatures from about 360° C. to about 550° C., more preferably from about 390° C. to about 500° C., still more preferably from about 400° C. to about 500° C. The process and system may comprise pyrolysis zones of different activity. For example, there may be primary pyrolysis zones in which the majority of pyrolysis occurs, which are preferably at temperatures above 390° C., and second pyrolysis zones in which the temperatures are above 360° C. but below 390° C. Pyrolysis zones are zones in the system, process of apparatus why pyrolysis occurs, or conditions for pyrolysis are generated.

The pyrolysis is, as commonly understood, carried out in the absence of oxygen, most preferably under an inert atmosphere. Nitrogen gas may provide an inert atmosphers. Before start-up the system may purged with nitrogen gas to provide at least an initial inert atmosphere.

The gas phase may preferably be composed of pyrolysis gases with oxygen being substantially absent, optionally including nitrogen.

The operating pressure of a cracked gas and cracking liquid separator vessel is preferably above ambient to ensure that ambient air does not enter the system. The pressure may be from 1 bar abs. to 5 bar abs., 1 bar abs. to 3 bar abs., 1 bar abs. to 2 bar abs., or 1 bar abs. to 1.5 bar abs, or 1 bar abs. to 1.05 bar abs. This is a lower pressure than the pressure present in the degassing zone, which degassing zone operates at higher pressures.

The invention preferably produces one or more hydrocarbon products, preferably wherein the hydrocarbon products include one or more of butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof.

Hydrocarbon products may be saturated, unsaturated, straight, cyclic or aromatic. Further product may include non-condensable gases, comprising methane, ethane, ethene and/or other small molecules. The products may be a source of feedstock for steam crackers of the manufacture of plastics.

The term “non-condensables” or “non-condensable gases” as variously referred to, identifies hydrocarbon fractions that are too volatile to condense in the distillation section, and that may, preferably will, exit the process as a gas. It is generally considered that non-condensable hydrocarbons in the pyrolysis process have from about 1 to about 7 carbon atoms. The non-condensables may include hydrocarbons that are saturated, unsaturated, straight, cyclic and/or aromatic.

The term “light hydrocarbons” or “LHC” as variously referred to, identifies hydrocarbon fractions that are condensable in the process and so obtainable as a liquid, yet which comprise short-chain molecules. It is generally considered that LHCs in the pyrolysis process have from about 3 to about 8 carbon atoms, possibly with some smaller portion of C2 molecules and/or C10 molecules. The LHCs may include hydrocarbons that are saturated, unsaturated, straight, cyclic and/or aromatic.

The term “heavy hydrocarbons” or “HHC” as variously referred to, identifies hydrocarbon fractions that are condensable in the process and so obtainable as a liquid, with generally longer chain composition than LHCs. It is generally considered that HHCs in the pyrolysis process have at least about 7 carbon atoms (possibly with some smaller portion of C6 molecules), preferably up to about 35 carbon atoms. Preferred ranges may include low range products of about 7 to about 20 carbon atoms, possibly with some smaller portion of C6 and/or C21 molecules. For the low range product, the final boiling point of the HHC may be about 430° C. Another preferred range may include medium range products of from about 8 to about 28 carbon atoms. For the medium range product, the final boiling point of the HHC may be about 450° C. Another preferred range may include high range products from about 10 to about 35 carbon atoms. For the high range product, the final boiling point of the HHC may be about 550° C. HHCs may include hydrocarbons that are saturated, unsaturated, straight, cyclic and/or aromatic.

It will be appreciated by the skilled reader dealing with petrochemicals, that there may be some variation in the boundary between non-condensables, LHC and HHC in a distillation process. Overlap and/or variation may be dependent, inter alia, upon chosen temperature, pressures and flow settings, and product specification may be adjusted to accommodate desired product qualities.

### BRIEF DESCRIPTION OF THE DRAWINGS

The features and advantages of the invention will be appreciated upon reference to the following drawings, in which:

FIG. 1 schematically illustrates an assembly for cracking long chained hydrocarbons;

FIG. 2 schematically illustrates an example embodiment having input extruder, heating zones and a degassing zone, useable in the assembly of FIG. 1;

FIG. 3 schematically illustrates a degassing dome provided between two heating zones, useable in the assembly of FIG. 1;

FIG. 4 schematically illustrates a degassing dome provided between two heating zones, useable in the assembly of FIG. 1; and FIG. 5 schematically illustrates a degassing dome provided between two heating zones, useable in the assembly of FIG. 1.

### DESCRIPTION AND ILLUSTRATIVE EMBODIMENTS

It will be appreciated that for simplicity and clarity of illustration, where considered appropriate, reference numerals may be repeated among the figures to indicate corresponding or analogous elements or steps. In addition, numerous specific details are set forth to provide a thorough understanding of the embodiments described herein. However, it will be understood by those of ordinary skill in the art that the embodiments described herein may be practiced without these specific details. Furthermore, this description is not to be considered as limiting the scope of the embodiments described herein in any way, but rather as merely describing the implementation of the various embodiments described herein. The following is a description of certain embodiments of the invention, given by way of example only and with reference to the drawings.

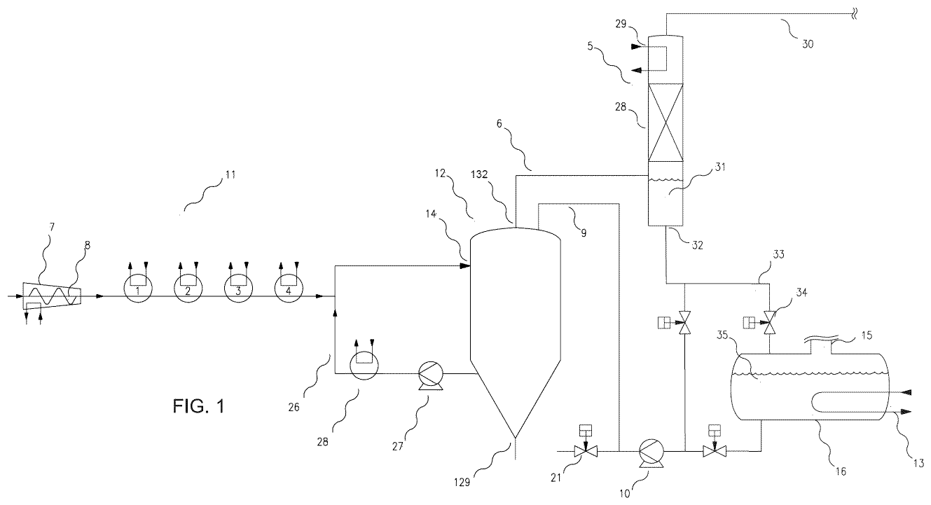

FIG. 1 shows an apparatus comprising a heating device 11 and a cracked hydrocarbon gas and cracking liquid separation vessel 12. The heating device 11 is in communication with the separation vessel 12 to feed fluids (liquids and gases) into the separation vessel 12. More specifically, the heating device 11 feeds fluids containing (partially) cracked hydrocarbons in both gaseous and liquid states into the separation vessel 12 at pyrolysis temperatures.

In some embodiments a feeding device 7 is arranged to fill material containing long chained hydrocarbons such as waste plastics as discussed, into the heating device 11. In some embodiments the feeding device comprises an effector 8 for heating and/or forwarding the material containing long chained hydrocarbons. In some embodiments the effector is a screw auger 8 arranged to forward and heat, the material containing long chained hydrocarbons. In some embodiments the screw auger 8 moves the material, and internal friction in the material causes the material to heat up and to melt. In further embodiments the feeding device 7 comprises a heating device such as an electrical heater or a heating device perfused by a heating medium such as thermal oil. The feeding device 7 drives the material containing long chained hydrocarbons to the heating device 11.

The material is preferably heated to approximately 250-325° C. in the extruder 7.

Moisture present in the plastic materials can be driven off and out of the plastics material at these temperatures, and released via an extruder gas release 200. The released gas may also contain pollutants and acidic materials, and so may preferably be neutralized with sodium hydroxide solution in a gas scrubber and disposed of.

Other pollutants may be organic materials resulting for example from food wastes or other materials for which the plastic may have been packaging material, e.g. oils, foods, cosmetics, hygiene products such as soap etc. Other pollutants may arise from plastic fillers or additives as may be generally added to plastics in order to improve some characteristics such as colour, gas barrier properties, elasticity etc. The pollutants may be seen as all, unwanted, materials that are driven out in the gas phase at this stage of the treatment.

In the illustrated embodiment, four heating zones are illustrated. Each of the heating zones 1, 2, 3, 4, may be a heat exchanger, preferably a shell and tube heat exchanger. The heating zones 1, 2, 3, 4 are in series and provide a flow path for the plastics material containing long chained hydrocarbons. The heating zones 1, 2, 3, 4 continuously or gradually increase the exposure temperature along the flow path. Heating is preferably done gradually to reduce or avoid char formation through excessive temperature differentials.

The heating device 11 heats and melts plastic material feedstock, raising its temperature to a pyrolysis temperature. Cracking may start in any of the heating zones 1, 2, 3, 4, with most cracking in the heating zones preferably occurring in heating zone 4, zone 4 being the hottest heating zone of the four. Pyrolysis temperatures may be 360° C. or greater, more preferably 390° C. or greater, preferably 395° C. or greater, preferably 400° C. or greater, more preferably 410° C. or greater. A pyrolysis temperature may be in the range of 360-550° C. more preferably 390-450° C.

In accordance with the invention, one or more degassing zones are included in the heating device 11, preferably between the heating zones 1, 2, 3, and/or 4. The degassing in the heating zone is preferably done in the temperature range of 220° C. to about 350° C., more preferably from about 280° C. to about 340° C., more preferably from about 300° C. to about 330° C., most preferably to about 330° C. At these temperatures, it is believed that halogen containing plastics such as PVC undergo substantial cracking resulting in production of Cl containing gases, such as HCl, which may then be extracted as gas from the heated plastic liquid. Without wishing to be bound by theory, it is believed that application of a restricted temperature as above, may advantageously limit the cracking of plastic components such as polypropylene and polyethylene in the zone where HCl is removed.

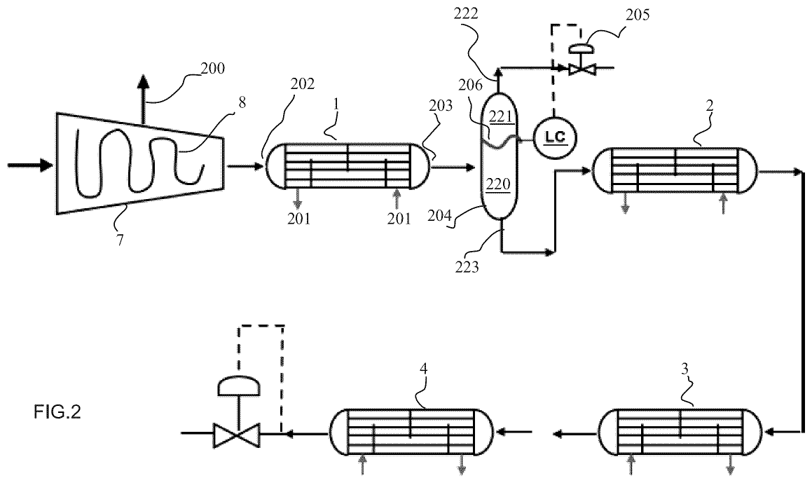

Turning to FIG. 2, there is illustrated an apparatus for heating and melting plastic feedstock to a liquid, followed by heating with removal of halogen, especially chlorine, pollutants. Solid waste-plastic feedstock comprising a portion of for example PVC is provided to extruder 7 wherein a screw auger 8 is arranged to forward, compress, and heat, the material containing long chained hydrocarbons. Internal friction in the plastic material under influence of the auger 8 causes the material to heat up and to melt. Moisture in the plastic material is driven off by heat and removed via gas release 200. The feeding device 7 further drives molten plastic to a first heating zone of the heating device 11.

The illustrated heating zone is a shell and tube heat exchanger 1 which may be heated with thermal oil provided to the shell as illustrated by arrows 201. The molten plastic material is passed into the heat exchanger 1 via inlet 202 and is driven through the tubes of heat exchanger 1, allowing for continuous flow heating of the molten plastic material. The first heating zone heats the molten plastic such that it increases in temperature, reaching a temperature upon exit from the first heating zone of about 220° C. to about 350° C. at the outlet 203. At these temperatures halogen containing plastic polymers, such a PVC will tend to pyrolyze leading to production of a chlorine containing gases, such as HCl. The gases result from pyrolysis within the bulk of the molten liquid and are in a dispersed state, also or alternatively due to flow turbulence in the tubes of the heat exchanger 1. An intermixed body of gases and liquid thus exits outlet 203 of the heat exchanger 1.

The intermixed body of gases and liquid exiting outlet 203 of the heat exchanger 1 passes to a degassing zone in the form of a degassing vessel (degassing dome) 204.

The illustrated degassing vessel 204 is elongate and vertically arranged. The intermixed body of gases and liquid separate in the degassing vessel 204 under gravity. A liquid body 220 forms in the lower portion and a gas body is formed in the upper portion, with a liquid level 206 defining a boundary therebetween.

Liquid body 220 is allowed to continuously exit via a liquid outlet 223 arranged in the lower portion of the degassing vessel 204 below the liquid level 206. The liquid then passes to a series of further heat exchangers 2, 3, 4 similar to the first heat exchanger 1. In each heat exchanger the molten plastic material is steadily heated to higher temperatures until heated to a final temperature in the range of 360° C. to about 550° C. prior to being passed as output liquid phase of the heating zones to the separation vessel 12.

The gas body 221 in the degassing vessel 204 is releasable via gas outlet 222 under control of gas outlet valve 205. Released gas may contain high levels of acidic gases such as HCl and so may be sent to a caustic scrubber.

The degassing vessel 204 is provided with one or more liquid level sensors systems LC. Such liquid level monitoring sensors may comprise radar, temperature, and/or gamma ray sensors. One, more or all of these sensors may provide a convenient and robust determination of liquid level in the degassing zone, preferably degassing vessel.

Control of the liquid level in the degassing chamber may be done by determining a liquid level via the provided sensors and adjusting a rate of gas release from the gas outlet 222 by control of gas outlet valve 205. The control may be implemented to maintain the liquid level in the degassing chamber below the gas outlet and above the liquid inlet and liquid outlet. In addition to, or alternatively, the liquid level in the degassing chamber may be adjusted by control of a rate of input and/or output of liquid for the degassing chamber to maintain the liquid level in the degassing chamber below the gas outlet and above the liquid inlet and liquid outlet.

The liquid level inside the degassing vessel 204 may be measured in a number of different ways. For accuracy, two or more, or all of the discussed alternatives may be implemented. Preferably the level control measurement comprises gamma, radar and temperature sensors.

The liquid level inside the degassing vessel 224 is complex to measure. Some sensors may fail due to fouling or degrade due to harsh conditions, other sensors may be inaccurate due to foaming at the liquid surface giving false readings.

A radar measurement device may be provided, preferably a guided wave radar measurement. The guided wave radar measurement is placed inside the degassing vessel 204. A guided wave radar level transmitter is placed on top of the degassing vessel 204. The guided wave radar measurement may provide a broad operating range, with good reliability. In particular, a rod type guided wave radar is suited for operation with foaming liquids, and the measurement operates independently of noise, pressure, temperature and density variations. Furthermore, fouling on the guided wave radar probe or on the separation vessel's inner surfaces, have minimal influence on the measurement accuracy.

A temperature measurement level sensor arrangement may be employed, preferably a multipoint temperature measurement sensor arrangement. The multipoint temperature measurement is placed inside the degassing vessel 204. A temperature measurement rod is equipped with a series of separate temperature sensors along a vertical length, for example from two or more, five or more, or about twelve or more, spaced along the vertical length of the rod. The level of the liquid can be assessed based on a difference in temperature between adjacent sensors on the rod. It has been determined that the liquid phase is typically if not always hotter than the gas phase by a number of degrees, for example a difference of from 3° C. to 6° C. between the gas and liquid phase.

The accuracy of the temperature measurement will depend upon the number of temperature sensors provided on the rod and the spacing thereof.

A further advantage of the temperature-based measurement of the liquid level is that information as to the overall process in the degassing dome may be simultaneously derived, especially during start up or transient situations.

External radiation measurement devices, preferably an external Gamma source level measurement device, may be employed for liquid level measurement.

The degassing vessel 204 is then equipped with an external radioactive level measurement device comprising a radiation source (preferably gamma or X-ray radiation) and a radiation detector. The liquid level may be determined based on whether liquid is present to block gamma rays at a given level. It has been found that radioactive level measurement provides accurate liquid level measurement despite dynamic processes and conditions in the pyrolysis zone, including foaming and potential fouling. In particular, radioactive level measurement does not require internal probes or other internal sensors.

The pressure in the degassing zones is preferably from 2 bar abs. to 80 bar abs., 3 bar abs. to 70 bar abs., 5 bar abs. to 60 bar abs. The pressure may be 2-10 bar abs. At these pressures, halogen containing gases may be extracted as gas from the heated plastic mass, in particular at the temperatures indicated above.

The pressure in the degassing zone will be at least partially dependent upon the rate of production of gas phase upstream of and in the degassing zone. The rate of production of gas phase may vary with varying feedstock composition, for example, less chlorine gases may be produced when a feedstock has low levels of PVC. To maintain pressure in the degassing zone, an inert gas, e.g. nitrogen gas, may be injected into the degassing zone.

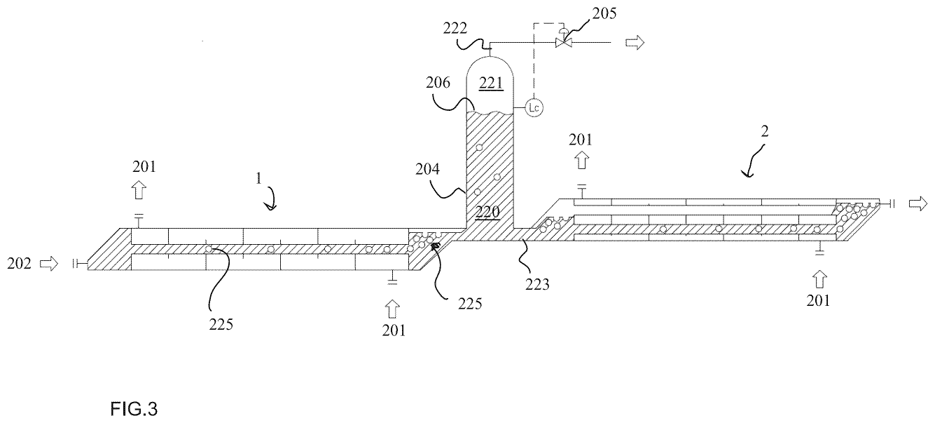

Turning to FIG. 3, there is shown a more detailed illustration of a degassing vessel 204 provided between a first heat exchanger 1 and a subsequent heat exchanger 2. Molten plastic flows from left to right in the illustrated embodiment. The molten plastic passes through the single tube of the first heat exchanger 1 and is heated to a temperature at which halogen containing plastics breakdown and produce halogen containing gas phase/bubbles 225, the concentration increasing as the molten plastic is steadily more heated in the first heat exchanger 1, to provide a dispersion of gas and liquid. The dispersion passes to the degassing vessel 204 where the gas and liquid phases separate into the gas body 221 and the liquid body 220. The gas body 221 is releasable via the gas outlet valve 205 under control of the liquid level control system LC, and the liquid is passed to the tubes of subsequent heat exchanger 2 via liquid outlet 223. Although not illustrated a further degassing vessel may be provided downstream of the subsequent heat exchanger 2.

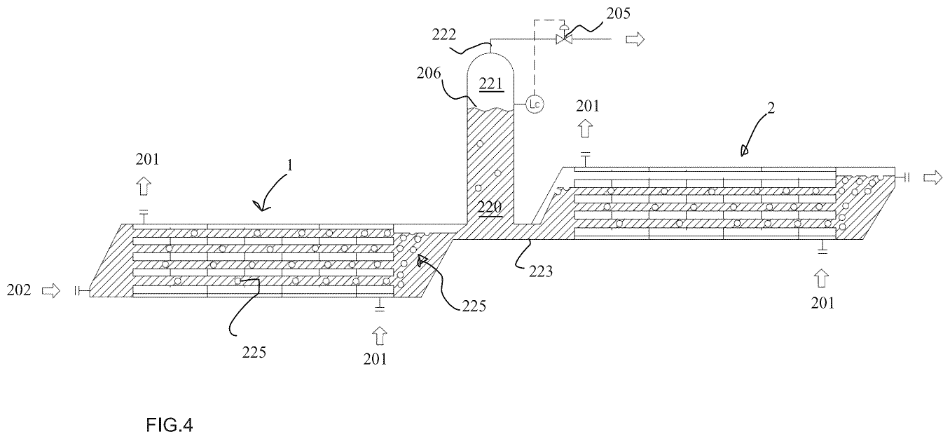

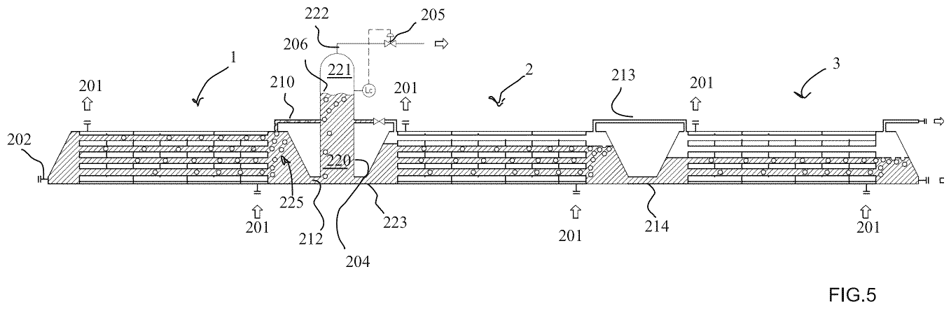

With reference to FIG. 4, there is illustrated a system similar to that of FIG. 3, differing for example in that the heat exchangers 1 ,2 are provided with a greater number of tubes, which may assist in improved heat transfer to the molten plastics material.

Turning to FIG. 5, an alternative embodiment is illustrated in which a degassing vessel 204 is provided between the first heat exchanger 1 and a second heat exchanger 2, and a third heat exchanger 3 is provided. In the illustrated embodiment, the heat exchangers 1, 2, 3 are vertically aligned. Gas 225 rises in the heat exchanger 1 towards a gas-line 210 linking an upper portion of the first heat exchanger 1 to the degassing vessel 204, while a liquid-line 212 is provided linking a lower portion of the first heat exchanger 1 to the degassing vessel 204. Gas 225 is able to rise within the first heat exchanger 1 to the gas-line and pass predominantly as a gas phase to the degassing vessel, where separation from the liquid is completed. A further gas-line 213 is provided allowing gases to pass directly from the second heat exchanger 2 to the third heat exchanger 3.

Returning to FIG. 1, the molten, partially pyrolyzed plastic material exits heating zone 4 at a pyrolysis temperature and passes into separation vessel 12 via separation vessel inlet 14.

In the separation vessel 12, incoming cracked gases and liquids separate. Gases will rise and exit to a partial condenser 5, and liquids fall to the bottom of the separation vessel 12.

A recycling loop 26 is provided to remove liquid, partially-pyrolyzed plastic material collected in the separation vessel 12 by way of pump 27. The removed liquid is reheated to a pyrolysis temperature by the heat exchanger 28, and then returned to the separation vessel 12, in the illustrated case together with fresh feed. This recycle loop 26 increases the residence time for long-chain hydrocarbons at pyrolysis temperature so that they are subjected to further pyrolysis and broken down to shorter-chain hydrocarbons, eventually exiting via the partial condenser 5.

The recycle loop 26 provides for reheating and reintroduction of heat to the separation vessel 12, such that the separation vessel 12 remains at a pyrolysis temperature. The heat is carried into the separation vessel 12 by the incoming reheated stream of material provided by the recycle loop 26.

In the illustrated, preferred embodiment, the separation vessel 12 is unheated.

The term “unheated” meaning not heated by any source other than heat carried by incoming heated material.

It has been found to be useful to avoid provision of heating means on or in the separation vessel, as may be found in some prior attempts. This may assist in reducing char formation in the separation vessel 12 and reduces or avoids requirements for special agitation means. For example, it has been found in prior attempts that an internal heater, such as a heating coil, can cause charring of pyrolyzing material at the surface of the heating element. That char may represent loss of product and may collect on the heating element requiring downtime for cleaning and maintenance. The same may be true in cracking reactor type vessels wherein the wall of the vessel is heated to bring or maintain the treated material at pyrolysis temperature. Charring may occur at the inner surface of the cracking reactor wall resulting in the need for complex mixing, cleaning and downtime. None the less, use of direct heating of the separator vessel, e.g. via a jacket or internal heat exchanger or heating coil, is not excluded from use in some embodiments or aspects of the invention and may be employed to a supply all or part of the heat requirement to the pyrolysis zone(s). For example, external heating such as a thermal oil jacket or electrical heating may be employed to maintain a minimal temperature during standby or startup.

In the illustrated, preferred embodiment, the separation vessel 12 is not provided with an agitator, such as a stirrer or auger. Without wishing to be bound by theory, it is believed that inclusion of an auger or similar stirring device to agitate liquid in the separator vessel may be disadvantageous because it introduces complexity; forms a surface area upon which carbon/char can accumulate so reducing efficiency and requiring maintenance; and may interrupt flow patterns imparted by injection or materials. However, optionally as may be useful to improve mixing inside the separation vessel 12, an agitator inside the separation vessel 12 may be provided or is not excluded from some embodiments and aspects.

At the point of entering the separation vessel 12 via inlet 14 the plastics material is undergoing pyrolysis because it is at a pyrolysis temperature. The cracking of the plastic material results in generation of a wide spectrum of substances with a wide range of boiling points. The plastics material exiting the heating device 11 and entering the separation vessel 12 via inlet 14 comprises at least both gaseous and liquid components, the liquid component comprises at least partially cracked plastics material, possibly consists substantially of partially cracked plastics material. The liquid component may also comprise molten, uncracked plastic material. The plastics material exiting the heating device 11 and entering the separation vessel 12 via inlet 14 may additionally comprise silt and other solid detritus, for example, sand, aluminium, or other metal particles.

The operating pressure of a cracked gas and cracking liquid separator vessel 12 is preferably above ambient to ensure that ambient air does not enter the system. The pressure may be from 1 bar abs. to 5 bar abs., 1 bar abs. to 3 bar abs., 1 bar abs. to 2 bar abs., or 1 bar abs. to 1.5 bar abs, or 1 bar abs. to 1.05 bar abs.

The illustrated separation vessel 12 is elongate and arranged substantially vertically. Non-vertical arrangements may also be envisioned, such as slanted or horizontal. Pyrolyzed gaseous material rises in the separation vessel 12 and liquid (partially) pyrolyzed material falls under gravity. In this manner, gaseous and liquid materials diverge and so separate in the separation vessel 12.

The gaseous hydrocarbon materials rising in the separation vessel 12 discharge via upper outlet 132 and pass via line 6 to the partial condenser 5. Partial condenser 5 is remote from the separation vessel 12 and is positioned downstream from the separation vessel 12. It is in fluid communication with the separation vessel 12 via the line 6. Line 6 is a gas line transporting gases to the partial condenser. Liquids do not pass to the line 6.

The partial condenser 5 is arranged and/or configured to remove heavy fractions (lower higher point fractions) from the exiting gas, prior to the exiting gas being further passed to full distillation or condenser sections of the apparatus and process. In the partial condenser 5 the gas is cooled as discussed below. As the gas is cooled, heavier fractions condense and can be collected, while lighter fractions remain gaseous and are passed via line to the reboiler 16.

The partial condenser 5 is preferably provided with a packed column 28 with (optional) random packing material such as rings e.g. Raschig rings, which increases the contact surface area between the gas and the liquid which is condensed in the partial condenser. As is known in condensation processes, this may assist in effective condensation by providing a large solid surface area for condensing gases.

The partial condenser 5 is also preferably provided with a temperature-controlled cooling element 29, such as a cooling coil supplied with temperature regulated cooling medium. The temperature of the cooling element 29 is controlled to cause condensation of long-chain hydrocarbons (longer than C22, for example), which condensed materials fall under gravity to the lower part of the partial condenser 5. The cooling element 29 is preferably downstream of the packed column 28, although other arrangements are possible.

As alternatives, or additionally, selective condensation may be achieved by a cooling jacket (not shown) acting as a cooling element, or the partial condenser may be an external (full reflux) condenser.

The gases that do not condense (C1-C20/C22, possibly up to C35) in the packed column 28 or in the cooling element 29 discharge via a partial condenser upper outlet and pass via line 30 to a downstream distillation unit of a type commonly known for distillation use in the petrochemical arts, for example as used in distillation of crude or mineral oil fractions.

The downstream distillation section can be designed according to industrial standards as known to those skilled in the art. The gases can be fractionated into gaseous fractions and liquid fractions. A liquid fraction may be stripped off as middle distillate, and a gaseous fraction may be stripped off as light boilers in a distillation unit. Hydrocarbon products from the distillation unit may comprise butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof, or any mixtures thereof. Hydrocarbon products may be saturated, unsaturated, straight, cyclic or aromatic. Further products may include non-condensable gases, comprising methane, ethane, ethene and/or other small molecules. The products may be a source of feedstock for steam crackers of the manufacture of plastics.

The hydrocarbons that condense in the partial condenser 5 (for example comprising ≥C22 chains, possibly including minor portions of <C22 carbon chains) collect as a liquid 31 at the bottom of the partial condenser 5.

The liquid level at the bottom of the partial condenser is controlled by one or more level control sensors and may be discharged batchwise or continuously. The level control in the partial condenser 5 can be achieved continuously by way of a flow control valve.

The condensed liquid 31 in the partial condenser is preferably discharged via a partial condenser lower outlet 32 and is passed to a reboiler 16 via line 33 controlled by optional valve 34. Valve 34 can be any of an open close valve or a control valve.

The condensed liquid 31 collects in the reboiler 16, where it is reheated by a heater 13, preferably an internal heating element or an internal heat exchanger. The reboiler heater 13 can be heated electrically, with thermal oil or other types of heating medium. The condensed liquid in the reboiler 16 is heated to a temperature higher than the temperature of the partial condenser. An external heating element or external heat exchanger may also be envisaged.

Light hydrocarbon fractions which may unavoidably be carried along with the partial condenser condensate liquid can in this manner be evaporated or boiled off and sent to the distillation apparatus via a reheater vessel upper outlet 15. These can then be included in the distilled products. This may improve product yields as compared to a system or process in which partially condensed material is directly returned to a pyrolysis zone. This may also be considered preferable to returning light hydrocarbons to a pyrolysis zone, where they may further crack or form a relatively useless heat drain as they are circularly heated to re-evaporate and thereafter recondensed.

The reboiler 16 is preferably comprised as a component of a distillation section and joined in fluid communication for gases via reheater vessel upper outlet 15.

Liquid 35 that is collected in the reboiler, and which does not evaporate through reheater vessel upper outlet 15 for distillation, may be pumped back into the separator vessel 12 via line 9 using pump 10, with optional further heating prior to entry into the separator vessel 12. The liquid may in this manner be further pyrolyzed to useful lighter products than those that condense in the partial condenser 5. For example, the liquid is returned to the separating vessel 12 and or pyrolysis zone and cracked until they are reduced to chain lengths of C20 to C22 or less. The product yield may thus be improved, and or the ratio of light to heavy products be more specified to customer requirements.

Alternatively, the liquid collected in the reboiler, and which does not evaporate through reheater vessel upper outlet 15 for distillation, may be collected as a useful product, for example the product may be paraffin, and be transported to a collecting vessel via valve 21.

The partial condenser coil 29 is typically operated at temperatures between 220° C. and 380° C. and the reboiler is typically operated at temperatures between 340° C. and 400° C. These temperatures are both lower than the typical crack reactor operating temperature of 390° C. and 450° C.

The liquid pyrolyzed material present in the separator vessel 12 is continuously circulated, preferably by means of an external pump 27. As the liquid is circulated it may be reheated to a pyrolysis temperature for further cracking by a heat exchanger 28.

A distillation column (not shown) is preferably provided atop reheater vessel upper outlet 15. The distillation column may be provided with a region designed as a packed column, and optionally within this region containing packing or preferably above this region, an intermediate tray on which the liquid fraction (diesel product or HHC) is collected and may be discharged. The HHC, for example diesel, product discharged from the distillation unit is preferably cooled by means of a heat exchanger, and a portion of this cooled diesel product may be recirculated to the distillation unit via a recycle streamline in order to set optimal temperature conditions.

Possible settings leading to low range product compositions may include:
a partial condenser outlet temperature of about 290° C.;
a reboiler (liquid) temperature of about 360° C.,
an upper distillation column outlet temperature of about 80° C.,
an LHC condenser temperature of the condensed LHC liquid of about 42° C. about
Final Boiling Point of HHC: 430° C.

Possible settings leading to medium range product compositions may include:
a partial condenser outlet temperature of about 320° C.;
a reboiler (liquid) temperature of about 380° C.,
an upper distillation column outlet temperature of about 100° C.,
an LHC condenser temperature of the condensed LHC liquid of about 42° C. about
Final Boiling Point of HHC: 450° C.

Possible settings leading to high range product compositions may include:
a partial condenser outlet temperature of about 330° C.;
a reboiler (liquid) temperature of about 380° C.,
an upper distillation column outlet temperature of about 120° C.,
an LHC condenser temperature of the condensed LHC liquid of about 55° C. about
Final Boiling Point of HHC: 550° C.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for heating a halogen containing plastics material to pyrolysis temperature, the process comprising the steps of:
heating and melting a halogen containing solid plastic feedstock to a temperature in the range of about 200° C. to about 325 C.;
removing water vapour and other gases emergent in the fluidizing and heating step;
passing the melted plastics material to a first heating zone,
further heating the body of melted plastics in said first heating zone to a higher temperature in the range of about 220 C. to about 350 C., producing a liquid phase and a gas phase, the gas phase being dispersed in the first heating zone;
allowing the liquid phase and dispersed gas phase to separate to provide a body of predominantly gas phase material comprising halogen containing compounds, and a body of liquid phase plastics material;
removing at least a portion of the gas phase;
passing the liquid phase material to one or more subsequent heating zones and further heating the liquid phase to a higher temperature that is a pyrolysis temperature; and
preferably passing an output liquid phase of the heating zones, at said pyrolysis temperature, to a pyrolysis reactor and/or distillation apparatus.

2. (canceled)

3. A process according to claim 1 wherein the separation of the intermixed liquid phase and gas phase of the first heating zone occurs predominantly downstream of the first said heating zone

4. A process according to claim 1 wherein the first heating zone is a heat exchanger, preferably a tube and shell heat exchanger, more preferably wherein the subsequent heating zones are also heat exchangers, preferably tube and shell heat exchangers.

5. (canceled)

6. (canceled)

7. (canceled)

8. (canceled)

9. (canceled)

10. A process according to claim 1 wherein an extruder is provided and wherein the step of heating and melting the halogen containing solid plastic feedstock is done in the extruder.

11. (canceled)

12. (canceled)

13. A process according to claim 1 wherein the step of heating and melting the halogen containing solid plastic feedstock comprises
compressing and heating the plastic feedstock to a temperature greater than 100 C., preferably to a temperature in the range of about 200 C. to about 320 C.,
thereafter reducing the pressure in at least one expansion zone, preferably a plurality of expansion zones, to liberate gases, preferably at least air and water vapour,
removing at least a portion of said liberated gases from the extruder; and
thereafter compressing and heating remaining plastics material to a temperature from about 200° C. to about 320°C.

14. (canceled)

15. A process according to claim 1 wherein a degassing zone is provided intermediate the first heating zone and the subsequent heating zone, in which degassing zone the liquid phase and gas phase produced in the first heating zone separate, and from which degassing zone at least a portion of the gas phase is removed, preferably under negative pressure.

16. (canceled)

17. (canceled)

18. A process according to claim 15, wherein the degassing zone comprises a degassing vessel distinct from the heating zones, preferably a degassing dome.

19. (canceled)

20. A process according to claim 1 wherein the degassing zone is at a pressure of greater than 2 bar abs., preferably from 2 bar abs. to 80 bar abs., preferably from 2 bar abs. to 60 bar abs., preferably 2 bar abs. to 50 bar abs., most preferably from 2 to 10 bar abs.

21. A process according to claim 1 wherein said halogen is selected from the group consisting of chlorine, bromine, fluorine, and mixtures thereof, preferably wherein the halogen is chlorine.

22. (canceled)

23. (canceled)

24. A process according to claim 1 wherein the solid plastic feedstock comprises polyvinylchloride plastics, preferably greater than 1 wt. % of polyvinylchloride plastics, more preferably greater than 5 wt. %, or wherein the feedstock comprises polyvinylchloride plastics at less than 5 wt. %, more preferably less than 1 wt. %.

25. (canceled)

26. (canceled)

27. (canceled)

28. An apparatus for heating a halogen containing plastics material to pyrolysis temperature, the device comprising:
a heating and melting section arranged to heat and melt a halogen containing solid plastic feedstock to a temperature in the range of about 200 C. to about 325 C., wherein the heating and melting section is provided with an inlet for said plastic feedstock, at least one gas outlet for release of gases emergent from the plastic feedstock during heating and melting, and an outlet for molten plastics material;
a first heating zone arranged to be fed molten plastics material from the heating and melting section, and further arranged to heat melted plastics material to a temperature in the range of about 220 C. to about 350 C. producing a liquid phase and a gas phase, the gas phase being dispersed in the first heating zone;
a degassing zone provided with an inlet arranged to be fed said liquid phase and dispersed gas phase from the first heating zone, the degassing zone being arranged to allow said dispersed gas phase and said liquid phase to separate into a body of predominantly gas phase material and a body of liquid phase plastics material; the degassing zone further comprising an gas outlet for release of said separated gas phase and a liquid outlet for release of said separated liquid phase, preferably wherein the gas outlet is higher than the liquid outlet;
at least one subsequent heating zone arranged to receive said liquid phase from the degassing zone liquid outlet, the heating zone being arranged to heat the liquid phase to a higher temperature, preferably to a pyrolysis temperature.

29. An apparatus according to claim 28 wherein the heating and melting section comprises an extruder for heating and melting solid plastic feedstock.

30. (canceled)

31. (canceled)

32. An apparatus according to claim 28 wherein the first heating zone is a heat exchanger, preferably a tube and shell heat exchanger.

33. (canceled)

34. An apparatus according to claim 28, wherein the degassing zone is unheated during degassing.

35. (canceled)

36. An apparatus according to claim 28, wherein the degassing zone comprises a degassing vessel distinct from the heating zones, preferably wherein the degassing vessel comprises a degassing dome.

37. (canceled)

38. A process for lowering halogen, preferably chlorine, content of a waste-plastics material, comprising the steps of:
heating a body of halogen containing melted plastics in a first heating zone to a temperature within the range of about 220 C. to about 350 C., producing a mixed body of liquid phase and a gas phase, the gas phase being dispersed within the liquid phase;
passing the mixed body of dispersed gas and liquid via an outlet of the first heating zone to a degassing chamber, allowing the dispersed gas phase to separate from the liquid phase in the degassing chamber to provide a body of predominantly gas phase material comprising halogen containing compounds, preferably comprising hydrogen chloride, and a body of liquid phase plastics material;
releasing at least a portion of the gas phase from the degassing chamber via a gas outlet in the degassing chamber; and
passing the liquid phase material via a liquid outlet in the degassing chamber, to one or more subsequent heating zones and further heating the liquid phase to a higher temperature that is a pyrolysis temperature.

39. A process in accordance with claim 38 wherein the degassing chamber is vertically elongate having height, the chamber being provided with a liquid inlet, the liquid outlet being arranged lower in the height of the chamber than the gas outlet, wherein the process further comprises the steps of passing the mixed body of dispersed gas and liquid via the outlet of the first heating zone to the liquid inlet of the degassing chamber.

40. (canceled)

41. A process according to claim 38, further comprising a step of providing the heated halogen containing melted plastics material by heating and melting a solid, halogen containing plastic feedstock, for example waste-plastic particles or waste-plastic pellets comprising polyvinylchloride, to a temperature in the range of about 200° C. to about 325 C. and passing said heated halogen containing melted plastics material to said first heating zone.

42-49. (canceled)
